(19) United States
(12) Patent Application Publication
(10) Pub. No.: US 2026/0227479 A1
(43) Pub. Date: Aug. 6, 2026

(54) SYSTEM FOR DETERMINING THE DIRECTION OF AN ACOUSTIC WAVE USING A CAPACITIVELY COUPLED CIRCUIT

(71) Applicant: Toyota Motor Engineering & Manufacturing North America, Inc., Plano, TX (US)

(72) Inventors: Taehwa Lee, Ann Arbor, MI (US); Ziqi Yu, Ann Arbor, MI (US); Xiaopeng Li, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/042,392

(22) Filed: Jan. 31, 2025

(51) Int. Cl. G01S 3/803

(52) U.S. Cl. CPC G01S 3/8034

(57) ABSTRACT

Systems for determining the direction of acoustic waves are described herein. In one example, a system for determining the direction of an acoustic wave includes a capacitively coupled circuit having a first circuit and a second circuit, a first transducer connected to the first circuit, and a second transducer connected to the second circuit. The system may include a memory in communication with a processor and having instructions that, when executed by the processor, cause the processor to determine the direction of an acoustic wave detected by the first and second transducers using a first voltage from the first circuit and a second voltage from the second circuit.

### TECHNICAL FIELD

The subject matter described herein relates, in general, to systems for determining the direction of an acoustic wave using a capacitively coupled circuit.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Sensing the incident angle of acoustic waves is required for many applications, such as applications involving the localization of a sound source. Systems for sensing acoustic incident angle usually measure the difference in acoustic wave arrival time, or phase difference, at two or more spaced-apart microphones. A significant disadvantage of this approach is that it generally requires a substantial distance between the multiple microphones, making it difficult to use a compact design. Thus, such phase-difference acoustic direction sensing systems are difficult to adapt to applications requiring or benefiting from a small size.

### SUMMARY

This section generally summarizes the disclosure and is not a comprehensive explanation of its full scope or all its features.

In one embodiment, a system for determining the direction of an acoustic wave includes a capacitively coupled circuit having a first circuit and a second circuit, a first transducer connected to the first circuit, and a second transducer connected to the second circuit. The system may include a memory in communication with a processor and having instructions that, when executed by the processor, cause the processor to determine the direction of an acoustic wave detected by the first and second transducers using a first voltage from the first circuit and a second voltage from the second circuit.

In another embodiment, a method includes the step of determining the direction of an acoustic wave detected by first and second transducers using a first voltage from a first circuit connected to the first transducer and a second voltage from a second circuit connected to the second transducer, wherein the first and second circuits form a capacitively coupled circuit.

In another embodiment, a capacitively coupled circuit includes a first inductor-resistor-capacitor circuit configured to be connected to a first transducer and a second inductor-resistor-capacitor circuit connected to the first inductor-resistor-capacitor circuit via a connecting capacitor and configured to be connected to a second transducer.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates an example of a system for determining the direction of an acoustic wave using a capacitively coupled circuit.

FIG. 2 illustrates a more detailed view of the capacitively coupled circuit of FIG. 1.

FIG. 3 illustrates a more detailed view of the data acquisition system for use with the system for determining the direction of an acoustic wave of FIG. 1.

FIG. 4 illustrates a method for determining the direction of an acoustic wave using a capacitively coupled circuit.

FIGS. 5A-5C illustrate different voltage readings across a range of frequencies generated by the capacitively coupled circuit when the system detects acoustic waves having incident angles of 0°, 45°, and 90°, respectively.

FIG. 6 illustrates changes in the voltage ratios of the voltages output by the capacitively coupled circuit as the system detects acoustic waves from different directions.

### DETAILED DESCRIPTION

Described are systems for determining the direction of an incoming acoustic wave using a capacitively coupled circuit that includes two separate circuits that are connected via a capacitor. In one example, the system utilizes two transducers that are spaced apart by a known distance. One of the transducers is attached to one circuit of the capacitively coupled circuit, while the other transducer is attached to the other circuit of the capacitively coupled circuit. A data acquisition system takes voltage readings from both circuits of the capacitively coupled circuit and, based on a comparison of the readings from both circuits, determines the direction of an acoustic wave sensed by the transducers.

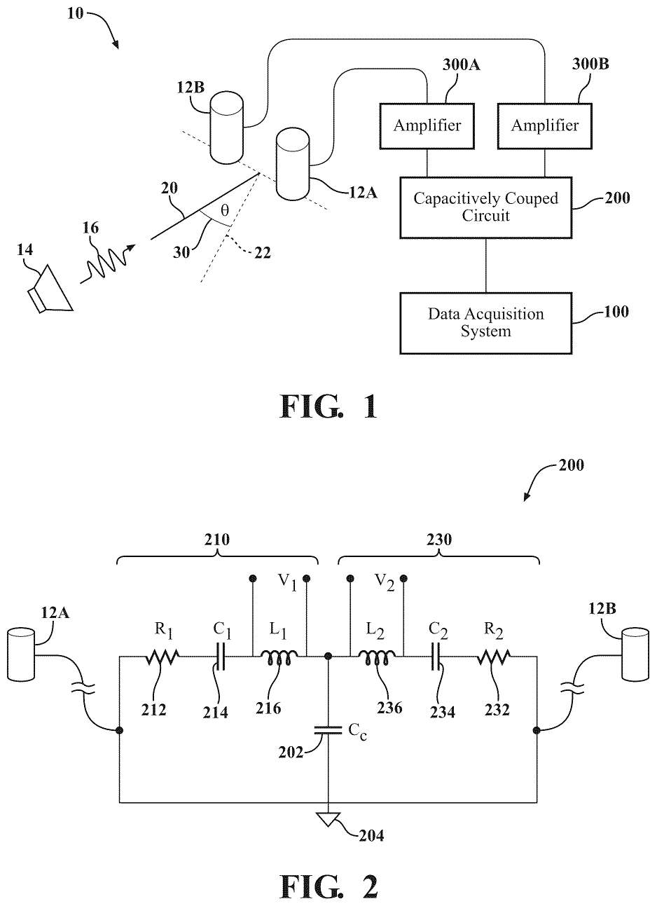

Referring to FIG. 1, illustrated is one example of a system 10 for determining the direction 30 of an acoustic wave 16 that may be generated by a source 14, such as a speaker or other source capable of generating the acoustic wave 16. It should be understood that the direction 30 of the acoustic wave 16 may be determined relative to transducers 12A and 12B, which are generally separated by a known distance Dₜ, which can vary from application to application. Moreover, the direction 30 may be in the form of an incidence angle relative to a line 22 defined between the transducers 12A and 12B. Moreover, a line 20 may be defined between the transducers 12A and 12B. In this example, the line 22 may run perpendicular to the line 20 and generally between the transducers 12A and 12B. As will be explained in greater detail later in this description, the direction 30 may be determined in one example by calculating a ratio between two different voltage amplitudes generated by the capacitively coupled circuit 200. Once calculated, the ratio is then utilized along with a mapping that maps the ratio to particular direction.

The transducers 12A and 12B may be any device that converts mechanical and/or sound energy into electrical signals. Moreover, the transducers 12A and 12B operate based on the principle of transduction, where one form of energy is transformed into another. As such, the transducers 12A and 12B may be microphones that convert acoustic waves into electrical signals. The transducers 12A and 12B output the signals based on the sound energy of the acoustic wave 16 to the capacitively coupled circuit 200. While the transducers 12A and/or 12B can take any one of a number of different forms, in one example, the transducers 12A and/or 12B may be microphones and, further still, the microphones may be micro-electro-mechanical system (“MEMS”) microphones. A MEMS microphone is a small, pressure-sensitive microphone created using semiconductor technology. It may include a diaphragm etched into a silicon wafer, which moves in response to sound waves. This movement creates an electrical signal that can be amplified and converted into digital data.

Optionally, the signals outputted by the transducers 12A and/or 12B may be amplified by amplifiers 300A and/or 300B, respectively, to amplify the signals. Moreover, the amplifiers 300A and/or 300B may boost low-level audio signals, such as those outputted by the transducers 12A and/or 12B, to a higher level. The amplifiers 300A and/or 300B may enhance the power of the audio signals outputted by the transducers 12A and/or 12B without significantly altering their original quality.

The amplified signals from the amplifiers 300A and 300B are then provided to a capacitively coupled circuit 200. The capacitively coupled circuit 200, as will be explained later, includes two different circuits (sometimes referred to as different stages) that are connected to each other utilizing a capacitor. This type of coupling isolates the different circuits and prevents direct current (“DC”) bias. Moreover, FIG. 2 illustrates one example of the capacitively coupled circuit 200. Here, the capacitively coupled circuit includes is first circuit 210 and a second circuit 230 that are connected to each other via a connecting capacitor 202 (C_{C}). The first circuit 210 and the second circuit 230 may be substantially equal (i.e., within 10%) to each other and include the same components having the same parameters (i.e., such as the same (within 10%) inductance, resistance, and capacitance.)

Moreover, the first circuit 210 may be an inductor-resistor-capacitor circuit that includes a resistor 212 (R₁), a capacitor 214 (C₁), and an inductor 216 (L₁) that are connected in series, wherein the inductor 216 (L₁) is connected to the connecting capacitor 202 (C_{C}), and the resistor 212 (R₁) is connected to ground 204. Similarly, the second circuit 230 may be an inductor-resistor-capacitor circuit that includes a resistor 232 (R₂), a capacitor 234 (C₂), and an inductor 236 (L₂) that are connected in series, wherein the inductor 236 (L₂) is connected to the connecting capacitor 202 (C_{C}), and the resistor 232 (R₂) is connected to ground 204. The resistance of the resistors 212 (R₁) and 232 (R₂), the capacitance of the capacitors 214 (C₁) and 234 (C₂), and the inductance of the inductors 216 and 236 (L₂) may be substantially equal to one another. As such, the resistors 212 (R₁) and 232 (R₂) may have the same resistance, the capacitors 214 (C₁) and 234 (C₂) may have the same capacitance, and the inductors 216 and 236 may have the same inductance. Generally, the capacitance of the connecting capacitor 202 (C_{C}) may be greater than that of the capacitors 214 (C₁) and/or 234 (C₂). In one example, the capacitance of the connecting capacitor 202 (C_{C}) may be approximately five times greater than the capacitance of the capacitors 214 (C₁) and/or 234 (C₂).

The transducers 12A and 12B are connected between the first circuit 210 and the second circuit 230, respectively, and the ground 204. When an acoustic wave is detected by the transducers 12A and 12B, voltages V₁ and V₂ are generated across the inductors 216 and 236 (L₂), respectively. As will be explained in the paragraphs that follow, the voltages V₁ and V₂ will be utilized by the data acquisition system 100 to determine the direction 30 of the acoustic wave 16 detected by the transducers 12A and 12B.

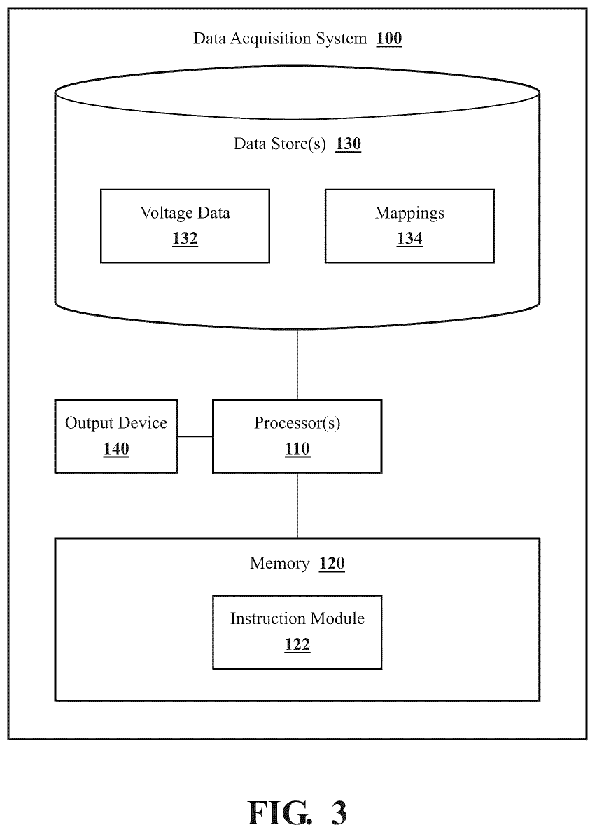

FIG. 3 illustrates a more detailed view of the data acquisition system 100 that will be utilized to determine the direction 30 of the acoustic wave 16, shown in FIG. 1. It should be understood that the data acquisition system 100 is just one example that the data acquisition system 100 may take. As such, the data acquisition system 100 may have more, fewer, or even different components than those illustrated in FIG. 3.

Here, in this example, the data acquisition system 100 includes one or more processor(s) 110. Accordingly, the processor(s) 110 may be a part of the data acquisition system 100, or the data acquisition system 100 may access the processor(s) 110 through a data bus or another communication path. In one or more embodiments, the processor(s) 110 is an application-specific integrated circuit that is configured to implement functions associated with an instruction module 122. In general, the processor(s) 110 is an electronic processor, such as a microprocessor, which is capable of performing various functions as described herein.

The data acquisition system 100 may also include an output device 140 that is in communication with the processor(s) 110. The output device 140 can be any device that is capable of outputting information generated by the data acquisition system 100, such as the direction 30 of the acoustic wave 16. As such, the output device 140 could be a monitor, printer, virtual reality headset, or speaker or could act as a conduit to communicate with other devices (i.e., network access device), either wired or wirelessly.

In one example, the data acquisition system 100 includes a memory 120 that stores instruction module 122. The memory 120 may be a random-access memory (RAM), read-only memory (ROM), a hard disk drive, a flash memory, or other suitable memory for storing the instruction module 122. The instruction module 122 is, for example, computer-readable instructions that, when executed by the processor(s) 110 cause the processor(s) 110 to perform the various functions disclosed herein.

Furthermore, in one example, the data acquisition system 100 includes a data store(s) 130. The data store(s) 130 is, in one embodiment, an electronic data structure such as a database that is stored in the memory 120 or another memory and that is configured with routines that can be executed by the processor(s) 110 for analyzing stored data, providing stored data, organizing stored data, and so on. Thus, in one embodiment, the data store(s) 130 stores data used by the instruction module 122 in executing various functions.

In this example, the data store(s) 130 may include voltage data 132 collected from the capacitively coupled circuit across the inductors 216 (L₁) and 236 (L₂). Moreover, when the transducers 12A and 12B sense the acoustic wave 16, a signal will be generated by the transducers 12A and 12B, which is amplified by the amplifiers 300A and 300B. This then results in the voltages V₁ and V₂ being generated across the inductors 216 (L₁) and 236 (L₂), respectively. The voltages V₁ and V₂ are then saved as corresponding pairs in the voltage data 132.

The mappings 134 may be in the form of a reference table that references a particular ratio of a corresponding pair of voltages V₁ and V₂ to an angle (mapped direction), which indicates the direction of a sensed acoustic wave. Moreover, the ratio of the corresponding pair of voltages V₁ and V₂ in the mappings 134 may be the ratio of the corresponding pair of voltages V₁ and V₂ generated when the acoustic wave 16 is sensed by the transducers 12A and 12B. The reference table may reference this ratio to an angle, which indicates the direction 30 of the acoustic wave 16. As such, by using the mappings 134 and the voltage data 132, the direction 30 of the acoustic wave 16 can be determined.

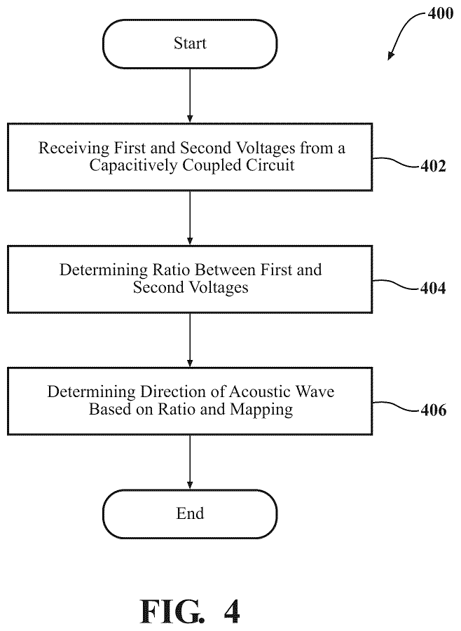

The instruction module 122 contains instructions that cause the processor(s) 110 to perform any of the methodologies described herein. With reference to FIG. 4, illustrated is a method 400 for determining the direction of an acoustic wave using a capacitively coupled circuit. The method 400 will be described from the viewpoint of the system 10 in FIG. 1. However, it should be understood that this is just one example of implementing the method 400. While the method 400 is discussed in combination with the system 10, it should be appreciated that the method 400 is not limited to being implemented within the system 10 but is instead one example of a system that may implement the method 400. As such, the method 400 may be embodied within the instruction module 122 as processor-executable instructions that, when executed by the processor(s) 110, cause the processor(s) 110 to perform the method 400.

Moreover, in step 402, the instruction module 122 includes instructions that, when executed by the processor(s) 110, causes the processor(s) 110 to receive a first voltage (V₁) and a second voltage (V₂) from the capacitively coupled circuit 200. Alternatively, instead of receiving the first voltage (V₁) and the second voltage (V₂) directly from the capacitively coupled circuit 200, the first voltage (V₁) and the second voltage (V₂) may have been previously stored in the data store(s) 130 as the voltage data 132.

As mentioned before, the first voltage (V₁) may be the voltage across the inductor 216 of the first circuit 210, while the second voltage may be the voltage across the inductor 236 of the second circuit 230. Generally, the first voltage (V₁) and the second voltage (V₂) may be corresponding pairs of voltages measured at approximately the same time. As such, the first voltage (V₁) and the second voltage (V₂) are the voltages generated by the capacitively coupled circuit 200 when the acoustic wave 16 is sensed by the transducers 12A and 12B. As mentioned before, the first voltage (V₁) and the second voltage (V₂) may be stored as pairs as the voltage data 132 in the data store(s) 130.

In step 404, the instruction module 122 includes instructions that, when executed by the processor(s) 110, causes the processor(s) 110 to determine a ratio between the first voltage (V₁) and the second voltage (V₂). In one example, this may be determined by simply dividing the first voltage (V₁) by the second voltage (V₂) or vice versa.

In step 406, the instruction module 122 includes instructions that, when executed by the processor(s) 110, cause the processor(s) 110 to determine the direction 30 of the acoustic wave 16 based on the previously calculated ratio and the mappings 134. In one example, as mentioned before, the mappings 134 may be a reference table or lookup table that can be used to reference a particular ratio to the direction 30 (e.g., angle) of the acoustic wave 16. Once a direction is determined, the instruction module 122 may then cause the processor(s) 110 to output the direction to the output device 140. The values relating the ratio to a particular angle or vice versa may have been previously determined in a controlled setting, wherein both the direction and ratios are known.

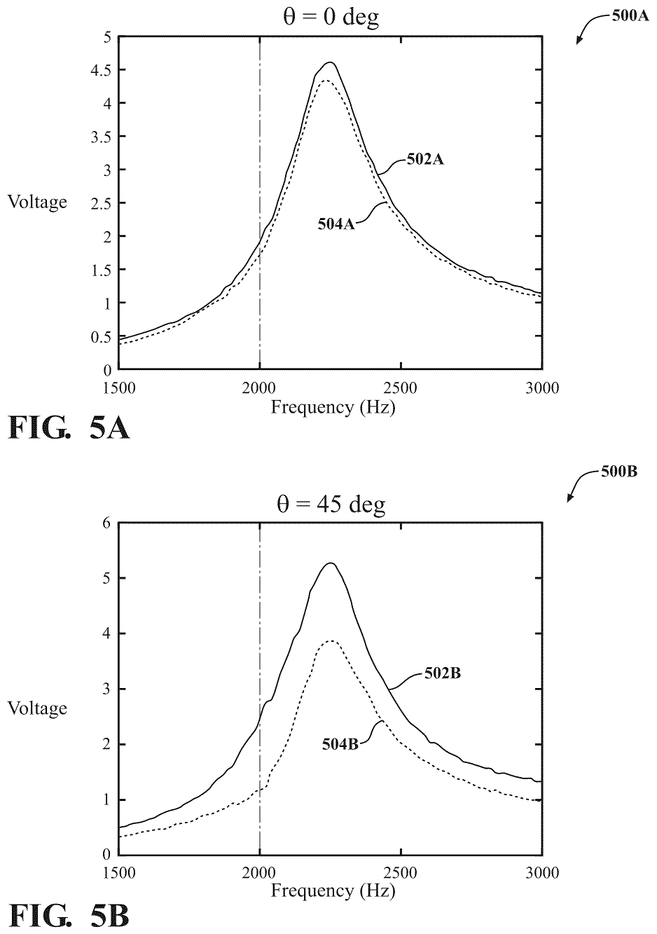

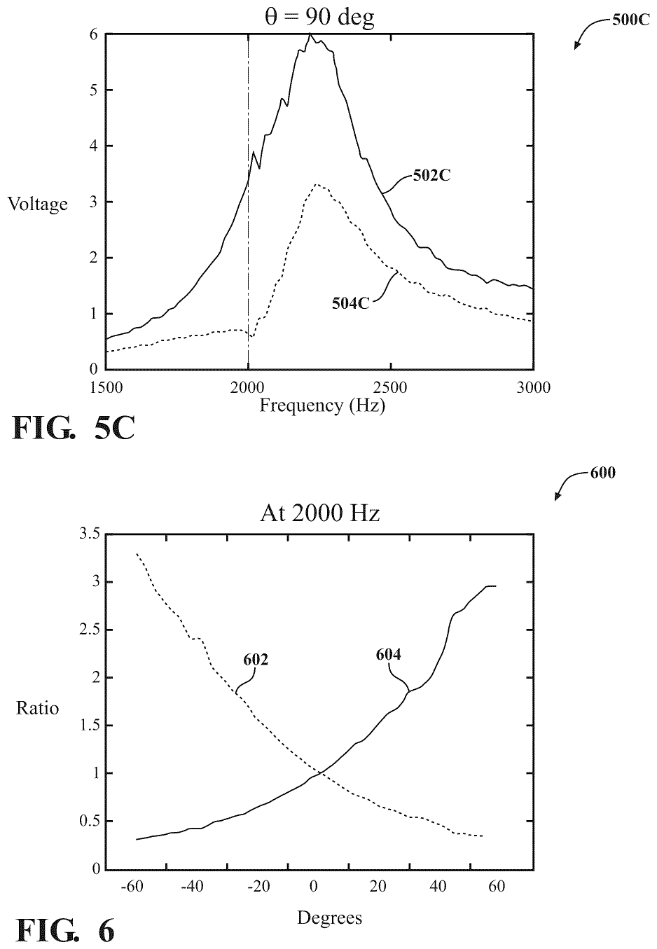

To better understand how a comparison (e.g., the ratio) of the first voltage (V₁) and the second voltage (V₂) is utilized to determine the direction 30 of the acoustic wave 16, reference is made to FIGS. 5A-5C. Moreover, FIG. 5A illustrates a chart 500A showing the value 502A of the first voltage (V₁) and the value 504A of the second voltage (V₂) across a frequency range of 1500-3000 Hz when the direction 30 is approximately 0°. Here, the mappings 134 essentially provide a numerical value regarding the direction with the ratios of the first voltage (V₁) and the second voltage (V₂) across a range of frequencies. As such, when one knows the ratio between the first voltage (V₁) and the second voltage (V₂), the mappings 134 can be utilized to determine the direction 30.

Similarly, FIG. 5B illustrates a chart 500B showing the value 502B of the first voltage (V₁) and the value 504B of the second voltage (V₂) across a frequency range of 1500-3000 Hz when the direction 30 is approximately 45°. In comparison to the chart 500A, it can be observed that the ratios of the first voltage (V₁) and the second voltage (V₂) are different from those when the direction was 0°. Continuing this trend, FIG. 5C illustrates a similar pattern, wherein the chart 500C shows the value 502C of the first voltage (V₁) and the value 504C of the second voltage (V₂) across a frequency range of 1500-3000 Hz when the direction 30 is approximately 90°. Like before, the ratios of the first voltage (V₁) and the second voltage (V₂) are different from those when the direction was 0°or 45°.

FIG. 6 illustrates a chart 600 of the ratios 602 and 604 of the first voltage (V₁) and the second voltage (V₂) when the acoustic wave has a frequency of 2000 Hz. The ratio 602 is V₁/V₂, while the ratio 604 is V₂/V₁. As can be seen in this example, the ratios 602 and/or 604 can be mapped to a corresponding direction of the incoming acoustic wave at a particular frequency.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures. The embodiments are not limited to the illustrated structure or application.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, indicating the scope hereof.

What is claimed is:

1. A system comprising:
a capacitively coupled circuit having a first circuit and a second circuit;
a first transducer connected to the first circuit and a second transducer connected to the second circuit; and
a memory in communication with a processor and having instructions that, when executed by the processor, cause the processor to determine a direction of an acoustic wave detected by the first and second transducers using a first voltage from the first circuit and a second voltage from the second circuit.

2. The system of claim 1, wherein the first and second circuits are inductor-resistor-capacitor circuits.

3. The system of claim 2, wherein at least one parameter of a resistor, a capacitor, and an inductor of the first circuit is substantially equal to at least one parameter of a resistor, a capacitor, and an inductor of the second circuit.

4. The system of claim 3, wherein a connecting capacitor that connects the first circuit to the second circuit has a capacitance greater than that of the capacitors of the first and second circuits.

5. The system of claim 4, wherein the connecting capacitor has a capacitance approximately five times greater than that of the capacitors of the first and second circuits.

6. The system of claim 2, wherein the first voltage is across an inductor of the first circuit and the second voltage is across an inductor of the second circuit.

7. The system of claim 6, wherein the memory further includes instructions that, when executed by the processor, cause the processor to, based on a ratio between the first voltage and the second voltage and a mapping that maps the ratio to a mapped direction, determine the direction of the acoustic wave detected by the first and second transducers.

8. The system of claim 1, wherein at least one of the first and second transducers is a microphone.

9. The system of claim 8, wherein the microphone is a micro-electro-mechanical system microphone.

10. The system of claim 1, further comprising an amplifier connected to at least one of the first transducer and the second transducer, and the capacitively coupled circuit.

11. A method comprising determining a direction of an acoustic wave detected by first and second transducers using a first voltage from a first circuit connected to the first transducer and a second voltage from a second circuit connected to the second transducer, wherein the first and second circuits form a capacitively coupled circuit.

12. The method of claim 11, wherein the first and second circuits are inductor-resistor-capacitor circuits.

13. The method of claim 12, wherein at least one parameter of a resistor, a capacitor, and an inductor of the first circuit is substantially equal to at least one parameter of a resistor, a capacitor, and an inductor of the second circuit.

14. The method of claim 13, wherein a connecting capacitor that connects the first circuit to the second circuit has a capacitance greater than that of the capacitors of the first and second circuits.

15. The method of claim 11, further comprising based on a ratio between the first voltage and the second voltage and a mapping that maps the ratio to a mapped direction, determining the direction of the acoustic wave detected by the first and second transducers.

16. A capacitively coupled circuit comprising:
a first inductor-resistor-capacitor circuit configured to be connected to a first transducer; and
a second inductor-resistor-capacitor circuit connected to the first inductor-resistor-capacitor circuit via a connecting capacitor, the second inductor-resistor-capacitor circuit configured to be connected to a second transducer.

17. The capacitively coupled circuit of claim 16, wherein at least one parameter of a resistor, a capacitor, and an inductor of the first inductor-resistor-capacitor circuit is substantially equal to at least one parameter of a resistor, a capacitor, and an inductor of the second inductor-resistor-capacitor circuit.

18. The capacitively coupled circuit of claim 17, a capacitance of the connecting capacitor is greater than that of the capacitors of the first and second inductor-resistor-capacitor circuits.

19. The capacitively coupled circuit of claim 18, wherein the capacitance of the connecting capacitor is approximately five times greater than that of the capacitors of the first and second inductor-resistor-capacitor circuits.

20. The capacitively coupled circuit of claim 16, wherein a ratio of a first voltage of the first inductor-resistor-capacitor circuit and a second voltage of the second inductor-resistor-capacitor circuit represents a direction of an acoustic wave detected by the first and second transducers.
